(19) United States
(12) Patent Application Publication
(10) Pub. No.: US 2014/0095250 A1
(43) Pub. Date: Apr. 3, 2014

(54) INNOVATION MANAGEMENT

(71) Applicant: ORACLE INTERNATIONAL CORPORATION, Redwood Shores, CA (US)

(72) Inventors: Gayle Hayes, Cupertino, CA (US); Andre Guldi, Offenbach (GE); David Wolfmueller, Karlsruhe (GE); Brett Shane Goodwin, Plano, TX (US); John Kelley, San Jose, CA (US); Shankar Muthane, San Jose, CA (US); Charu Roy, Saratoga, CA (US); Devendra Singh, Saratoga, CA (US)

(73) Assignee: Oracle International Corporation, Redwood Shores, CA (US)

(21) Appl. No.: 13/843,522

(22) Filed: Mar. 15, 2013

Related U.S. Application Data
(60) Provisional application No. 61/707,935, filed on Sep. 29, 2012.

(51) Int. Cl. G06Q 10/06

(52) U.S. Cl. CPC G06Q 10/0637
USPC 705/7.28; 705/7.36

(57) ABSTRACT

A system and method for facilitating facilitating management of innovations and accompanying constituent concepts. An example method includes providing a first user option to define one or more alternate solution categories for one or more concepts, wherein each alternate solution category is associated with an innovation comprising a structure of concepts, and wherein an alternate solution category is associated with an alternate solution structure; providing a second user option to define a concept as an alternate solution concept belonging to an alternate solution category; and associating one or more metric attributes with an alternate solution concept. The user options may be provided via a user interface display screen with additional user interface controls for generating analysis pertaining to alternative concept structures in association with one or more metrics, such as supply chain risk, cost, compliance, fulfillment, and/or other product objectives or metrics.

### CROSS REFERENCES TO RELATED APPLICATIONS

This application claims priority from U.S. Provisional Patent Application Ser. No. 61/707,935, entitled INNOVATION MANAGEMENT, filed on Sep. 29, 2012, which is hereby incorporated by reference as if set forth in full in this application for all purposes.

### BACKGROUND

The present application relates to software and more specifically to software and accompanying methods and user interfaces for facilitating managing development and implementation of innovations, such as product concepts.

Systems and methods for facilitating managing innovation development, e.g., new product development, are employed in various demanding applications, including enterprise development of advanced products and technologies, such as military aircraft, software, and so on. Such applications often demand informative software that can provide insight for making innovation-related decisions that can ultimately impact enterprise profitability and innovation development feasibility.

Insightful innovation management software and methods are particularly important in enterprise applications, where a given enterprise may be developing several products with varying requirements, costs, risks, and so on. Determining which innovations or products to pursue, which requirements to fulfill, and so on, can represent critical business decisions, which demand particularly insightful tools for managing information needed to make the critical decisions.

Conventionally, enterprises may employ business process management software to facilitate managing a development process pertaining to an innovation. However, such process management software generally lacks features, methods, and interfaces for fully informing enterprise decision makers about important factors involved in developing and managing a particular innovation.

### SUMMARY

Embodiments described herein provide various features for facilitating management of innovations and accompanying constituent concepts. A given innovation, also called overall concept or product herein, may be characterized by a concept structure, which may include a hierarchy of concepts. For example, a new product innovation, e.g., representing a product, may include several parts, wherein each part may represent a concept. In accordance with certain embodiments discussed herein, each concept or group of concepts of a concept structure may be associated with one or more requirements.

A first example embodiment includes various user interface display screen features for illustrating (e.g., generating analysis) information visualizations pertaining to alternative concept structures in association with one or more metrics, such as supply chain risk, cost, compliance, fulfillment, and/or other product objectives or metrics.

A second example embodiment provides various user interface display screen features for facilitating viewing, tracing, and managing relationships or associations between product requirements, concepts, and concept requirement fulfillment status. Concept requirement fulfillment status (also simply called requirement fulfillment status or just fulfillment status) may represent an indication as to whether a given concept is considered by a user (e.g., an engineer) to fulfill a given requirement that is associated with the concept, e.g., product or product component.

A third example embodiment provides various user interface display screen features for visually depicting (e.g., via an information visualization) and facilitating analysis of the health or strength of relationships or associations between ideas, product features, requirements, concept requirement fulfillment status or projected fulfillment status, concept structures (also called conceptual product structures), alternative concept structures, items, components, and portfolios.

A further understanding of the nature and the advantages of particular embodiments disclosed herein may be realized by reference of the remaining portions of the specification and the attached drawings.

### BRIEF DESCRIPTION OF THE DRAWINGS

FIG. 1A shows a first example user interface display screen, called a concept edit screen, with a requirements panel, a concept structure panel, and a details panel for viewing requirements, concepts, and details of concepts associated with an innovation.

FIG. 1B shows a second example user interface display screen with user options for activating, deactivating, adjusting names, and/or adjusting descriptions of alternate solutions representing alternate solution categories, also called solution alternatives, concept alternatives, or alternative concept categories.

FIG. 1C shows a third example user interface display screen with user options for assigning concepts to alternate solution categories.

FIG. 1D shows a fourth example user interface display screen illustrating metrics associated with different concepts that are associated with different alternate solution categories.

FIG. 1E shows an fifth example user interface display screen illustrating a visualization juxtaposing different metrics for different alternative solution categories, which represent concept structure alternates.

FIG. 2A shows a sixth example user interface display screen indicating concepts that have been assigned to a particular requirement and further showing user options to search for assigned concepts based on whether the concepts are considered to have fulfilled the identified requirement.

FIG. 2B shows a seventh example user interface display screen with user options for marking a concept as being fulfilled when the concept has been determined to be sufficiently mature to fulfill an associated requirement.

FIG. 3 shows an eighth example user interface display screen depicting an example concept structure and accompanying indications of health or strength of an association between concepts.

FIG. 4 is a diagram of an example system adapted for use with the embodiments of FIGS. 1-3.

### DETAILED DESCRIPTION OF EMBODIMENTS

Embodiments can provide new innovation management capabilities that enable detailed tracking and analysis of concepts and sub-concepts included in a concept structure characterizing an overall concept, called an innovation herein. Certain capabilities of embodiments discussed herein further enable creation of associations between concepts and concept requirements; determination of and association of metrics, such as cost, weight, status, and other scores, ratings, or values with concept and/or product requirements; graphical illustration of health and/or strength of an association (also called a relationship herein), and so on.

In general, certain embodiments discussed herein may be implemented via Graphical User Interface (GUI) software in communication with a database for storing information about innovations, such as descriptions of sub-concepts, risks associated with sub-concepts, and other related metrics or information, as discussed more fully below. The GUI software and database may be implemented on a single computer or may be distributed among different computers, e.g., on a client device and/or a server device in communication via a network, such as the internet.

For clarity, certain well-known components, such as hard drives, processors, operating systems, power supplies, the Internet, other networks, and so on, have been omitted from the figures. However, those skilled in the art with access to the present teachings will know which components to implement and how to implement them to meet the needs of a given application.

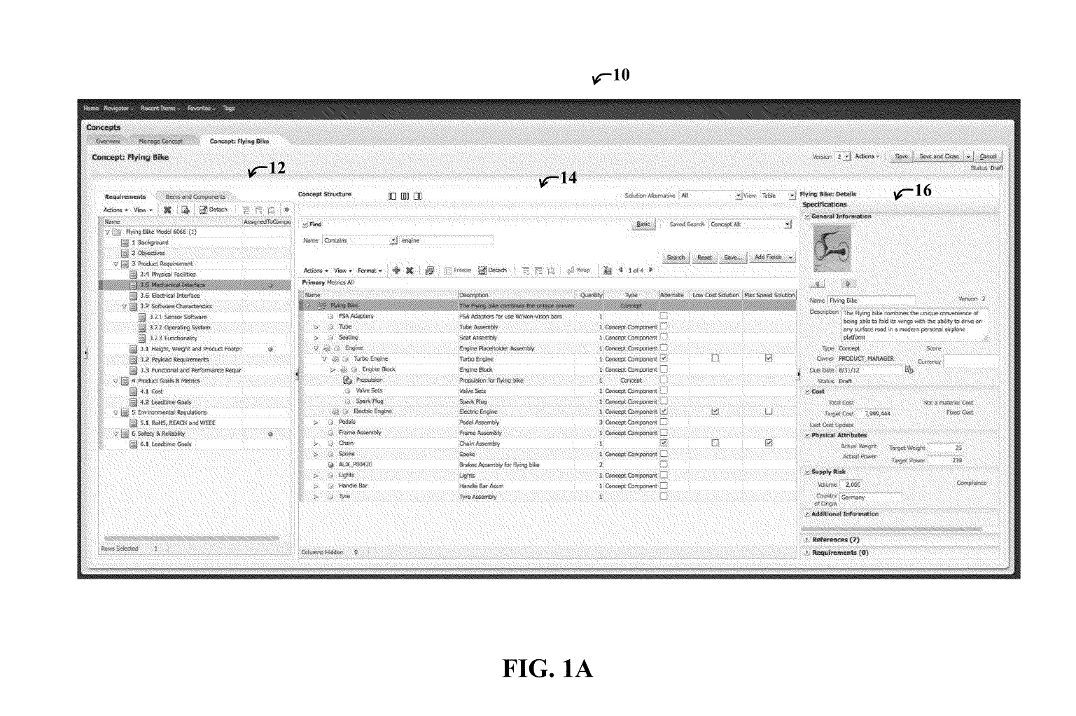

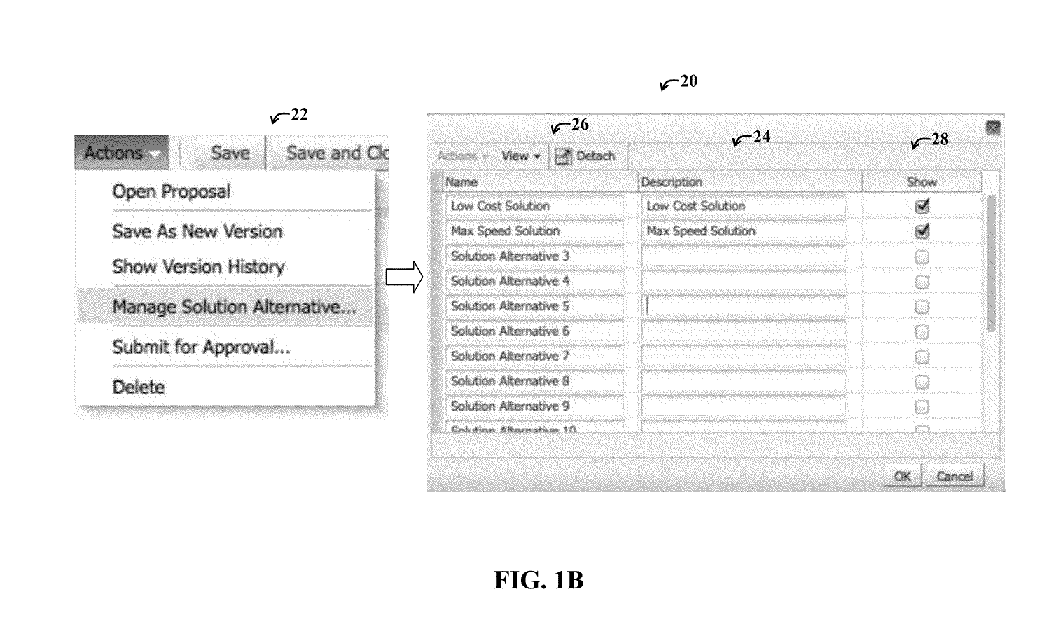

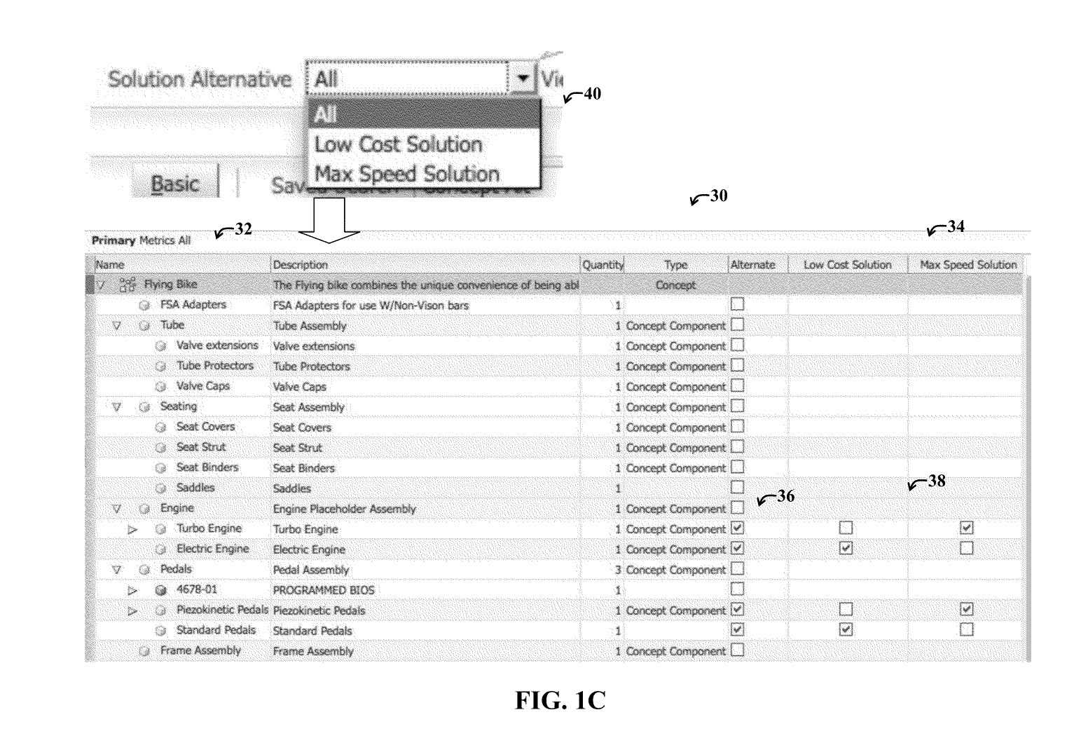

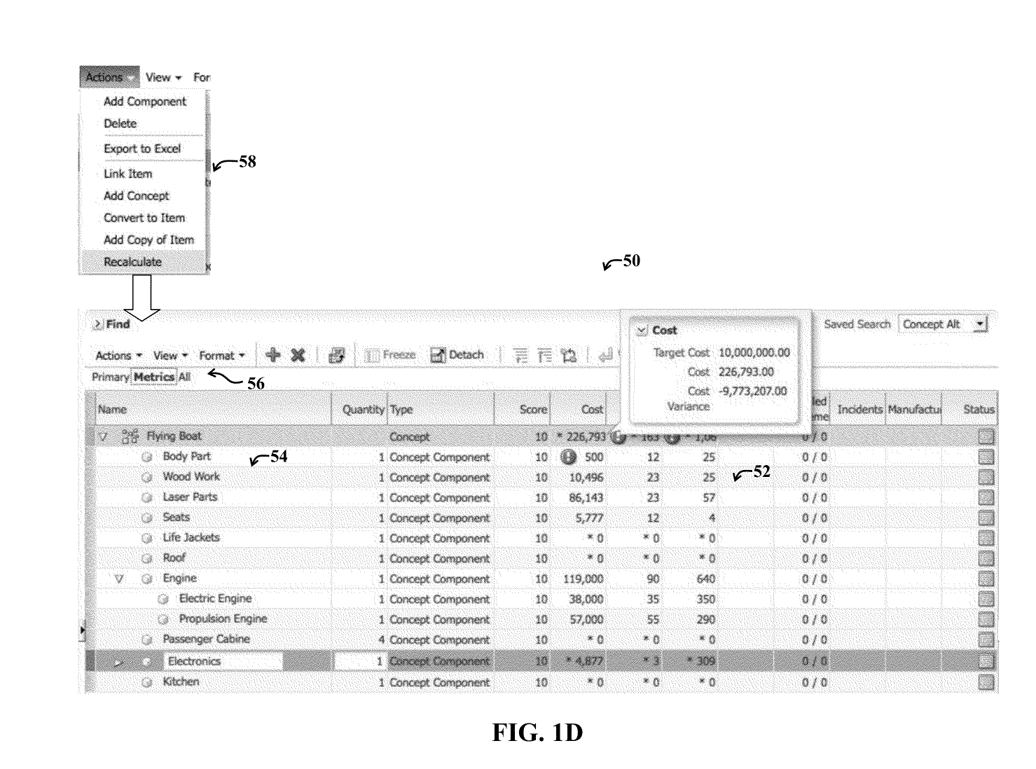

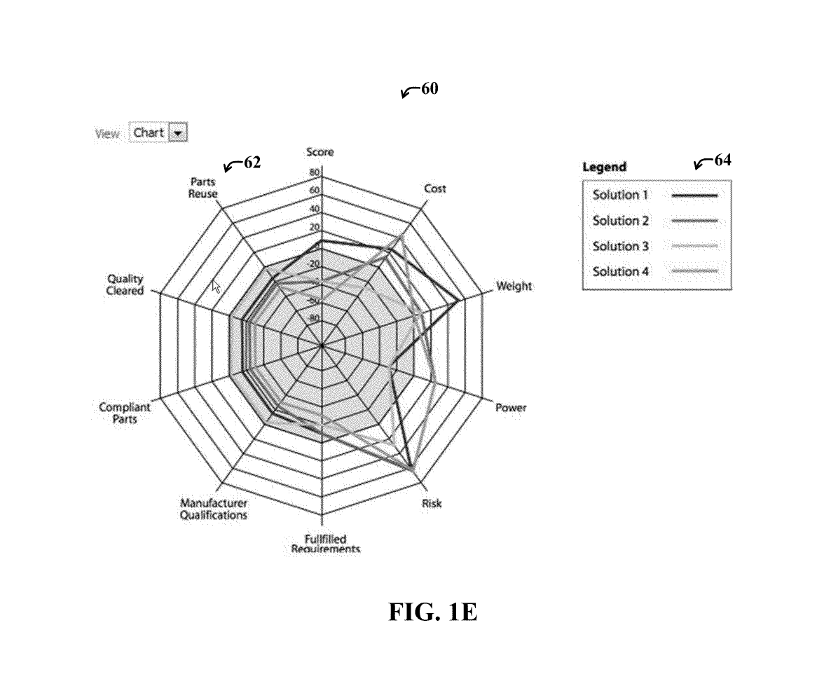

FIG. 1A shows a first example user interface display screen 10, called a concept edit screen, with a requirements panel 12, a concept structure panel 14, and a details panel 16 for viewing requirements, concepts, and details of concepts, respectively, associated with an innovation. The user interface display screen 10 may appear after creation of one or more innovations or concepts or after opening an existing innovation or contact via another user interface display screen.

For the purposes of the present discussion, a user interface display screen may be any software-generated depiction presented on a display, such as the touch display 22. Examples of depictions include windows, dialog boxes, displayed tables, and any other graphical user interface features, such as user interface controls, presented to a user via software, such as a browser. User interface display screens may include various graphical depictions, including visualizations, such as graphs, charts, diagrams, tables, and so on.

An innovation may refer to an overall concept, e.g., pertaining to a product, that may include several components. Hence, an innovation may itself represent a concept, and the constituent concepts of an innovation may represent sub-concepts of the innovation. For example, if an innovation pertains to a flying bicycle, the flying bicycle may have sub-components, such as pedals, chain, spokes, lights, handle bars, and so on, each of which may represent sub-concepts or sub-designs of the overall flying bicycle concept or design, which is called an innovation.

The overall concept and constituent sub-components may be associated with certain requirements. For example, the flying bicycle lights may require a certain brightness, a certain color, and so on. Such requirements may be established, for example, by selecting a concept or sub-concept from the concept structure panel 14 and then selecting a requirements user interface control at the bottom of the details panel 16. User selection of the requirements user interface control may trigger display of an additional field or dialog box wherein a user may specify details of a particular requirement or metric to be associated with a sub-concept.

For the purposes of the present discussion, a user interface control may be any displayed element or component of a user interface display screen, which is adapted to enable a user to provide input, view data, and/or otherwise interact with a user interface. Additional examples of user interface controls include buttons, drop down menus, menu items, tap-and-hold functionality, and so on. Similarly, a user interface control signal may be any signal that is provided as input for software, wherein the input affects a user interface display screen and/or accompanying software application associated with the software.

Components of an innovation or overall concept may fit within a hierarchical structure illustrated in the concept structure panel 14. The highest level concept of the concept structure panel 14 corresponds to the innovation. A given innovation may have sub-components called direct child components, which may themselves have sub-components, i.e., direct child components.

The user interface display screen 10 is adapted to facilitate innovation management for an innovation that may incorporate several concepts and that may be characterized by several requirements. Different concepts may be associated with different requirements, as indicated in the requirements panel 12.

For example, the flying bicycle innovation may have a mechanical interface requirement, an electrical interface requirement, a software characteristics requirement, and so on. Furthermore, each requirement may have sub-requirements. For example, the software characteristics requirement may have a sensor software requirement, an operating system requirement, and so on, as indicated in the requirements panel 12.

The details panel section 16 includes various sub-sections, e.g., as indicated by a Cost header, a Physical Attributes header, a Supply risk header, and so on. Such details-subsections provide various user options, e.g., user interface controls for defining, specifying, or modifying metrics and associated parameters. Note that in certain embodiments, user options for removing metrics from the details section 16 for a particular selected concept, sub-concept, or alternate solution category may be provided in corresponding sections of the details section 16. For example, a remove button and an add button for enabling such modifications may appear in each sub-section of the details panel section 16.

Facilitating Analyzing and Juxtaposing Alternate Solution Category Structures with Reference to Concept Metrics, Such as Supply Chain Risk, Cost, and so on

FIG. 1B shows a second example user interface display screen 20 with user options for activating, deactivating, adjusting names, and/or adjusting descriptions of alternate solutions representing alternate solution categories, also called solution alternatives, concept alternatives, or alternative concept categories. The display screen 20 may appear after selection of a “Manage Solution Alternative” option from an actions drop down menu 22, which may be accessible from a header bar of the requirements panel, i.e., section 12 of FIG. 1A.

Different alternative concept categories and alternative concept structures associated therewith, can be compared and evaluated relative to each other to facilitate design improvement, as discussed more fully below.

For a given concept structure, different alternative concept categories are user definable. The second example user interface display screen 20 includes a description column 24, which provides fields for enabling a user to enter and/or change or delete a description for a predetermined alternative concept category listed in a name column 26.

The second example user interface display screen 20, also called a Manage Solution Alternative screen, is adapted to enable activation and deactivation of a listed alternative concept category. In particular, a show column 28 provides check boxes for enabling a user to activate or deactivate an alternative concept category by selecting or deselecting, respectively, a corresponding check box adjacent to a named alternative concept category, e.g., as listed in the name column 26.

To change a name of an alternative concept category, a user may select and edit one of the fields of the name column 26. To alter a description of a named alternative concept category, a user may select and edit a description field (of the description column 24) adjacent to the named alternative concept category.

Changes, such as changes to a name, description, and/or activation status, of an alternative concept category may be reflected in a primary attribute group view of an associated concept structure, which may be accessible via a header bar (e.g., via a view menu thereof) of the concept structure panel 14 and which may be displayed in the concept structure panel 14 of FIG. 1A. In such a primary attribute group view, only one or more active solution alternatives will appear as additional columns in the concept structure panel 14 of FIG. 1A. In summary, changes made to an alternative concept category may be reflected in a primary attribute group view of a concept structure, which may be accessible via the concept structure panel 14 of FIG. 1A.

FIG. 1C shows a third example user interface display screen 30 with user options for assigning concepts 32 to alternate solution categories 34. The user interface display screen 30 represents an example concept structure panel (which may be displayed in the concept structure panel section 14 of FIG. 1A), whereby a user may mark concepts as “alternates” via alternate check boxes 36.

When a user marks a concept as an alternate, additional check boxes 38 appear in the user interface display screen 30 for the concepts corresponding to the checked boxes 38. The additional check boxes 38 represent user options for assigning, i.e., associating concepts 32 with one or more alternate solution categories 34, thereby creating one or more relationships or associations between one or more concepts and one or more alternate solution categories.

The concepts 32 displayed in the user interface display screen 30 may be filtered via a drop down menu 40 to indicate or show only concepts and related information that are part of an alternate solution category selected from the drop down menu 40. Note that the drop-down menu 40 may be accessible via the concept structure panel 14 of FIG. 1A.

FIG. 1D shows a fourth example user interface display screen 50 illustrating metrics 52 associated with different concepts 54 that are associated with different alternate solution categories. The display screen 50 may be presented in response to user selection of a recalculate option from an actions menu 58. The actions menu 58 may be accessible via a header bar of the concept structure panel 14 of FIG. 1A. Furthermore, the user interface display screen 50 may be displayed in the concept structure panel section 14 of FIG. 1A.

Display of different metrics for different concept solution categories may be via user selection of a filtering user interface control 56. Note that the user interface display screen 50 may include additional functionality and mechanisms for adjusting displayed metrics. For example, a right-click drop-down menu may appear in response to user right-clicking a header (e.g., Score, Cost, etc.). The menu may include additional user options for defining metrics, editing metrics, removing one or more columns pertaining to one or more of the metrics 52, e.g., a score metric, cost metric, and so on. The additional user options may further include a user option for adjusting how a metric, such as a score, is calculated; for filtering displayed metrics based on a user specified or predetermined criterion or criteria, and so on.

FIG. 1E shows an fifth example user interface display screen 60 illustrating a visualization, called a spider visualization, juxtaposing different example metrics 62 for different example alternative solution categories 64, which represent concept structure alternates, i.e., alternate solution categories. Note that a concept structure alternate may refer to an alternate solution category, such as “low cost solution” or “max speed solution” or other user defined or predefined alternate solution category.

For the purposes of the present discussion, a visualization may be any graphical depiction of data.

A comparison may be any juxtaposition of data to be compared. A comparison operation may be any operation or function that acts to juxtapose data to be compared. A juxtaposition may include any simultaneous presentation of or illustration of data to be compared. A juxtaposition may also include a combination of data to be displayed, where the combination shows or illustrates a difference or contrast between the data to be compared. A comparison view may be any user interface display screen that illustrates data for multiple resources to facilitate juxtaposition or comparison of the data.

Examples of metrics illustrated in FIG. 1E include a measurement of supply-chain risk (Risk), a measurement of cost (Cost) associated with a concept, a compliance measurement (Compliant Parts), a manufacturer qualifications metric (Manufacturer Qualifications), a cleared quality metric (Quality Cleared), a fulfilled requirements metric (Fulfilled Requirements), an aggregated metric (Score), and so on. The aggregated metric score may represent an aggregation or sum of metric attributes associated with some or all of the depicated alternate solution categories 64.

Hence, the embodiments of FIGS. 1A-1E facilitate generation of analysis, such as visualizations of alternative conceptual or born structures against one or more metrics, such as a score (which may be implementation specific), cost, weight, power consumption, risk (e.g., supply chain risk measurements or ratings), quality cleared status, compliance status, or other product objectives/metrics.

Note that various additional user interface display screens and accompanying underlying software routines may provide functionality for creating or defining concept metrics; for associating or computing concept metrics with one or more concepts; for aggregating concept metrics for different branches of a concept structure; for rolling up and facilitating juxtaposing aggregated concept metrics, and so on.

An example method that may be implemented via the user interface display screens and underlying software of FIGS. 1A-1E includes: providing a first user option to define one or more alternate solution categories for one or more concepts, wherein each alternate solution category is associated with an innovation comprising a structure of concepts, and wherein an alternate solution category is associated with an alternate solution structure; providing a second user option to define a concept as a alternate solution concept belonging to an alternate solution category; providing a third user option to assign a metric attribute to an alternate solution concept; and providing a fourth user option to trigger a comparison of different alternate solution categories that illustrates one or more metrics associated with different alternate solution structures corresponding to a collection of one or more alternate solution concepts of an alternate solution category.

### Facilitating Tracing or Tracking Relationships or Associations Between Product or Concept Requirement(s) and Product Design or Concept Fulfillment Status

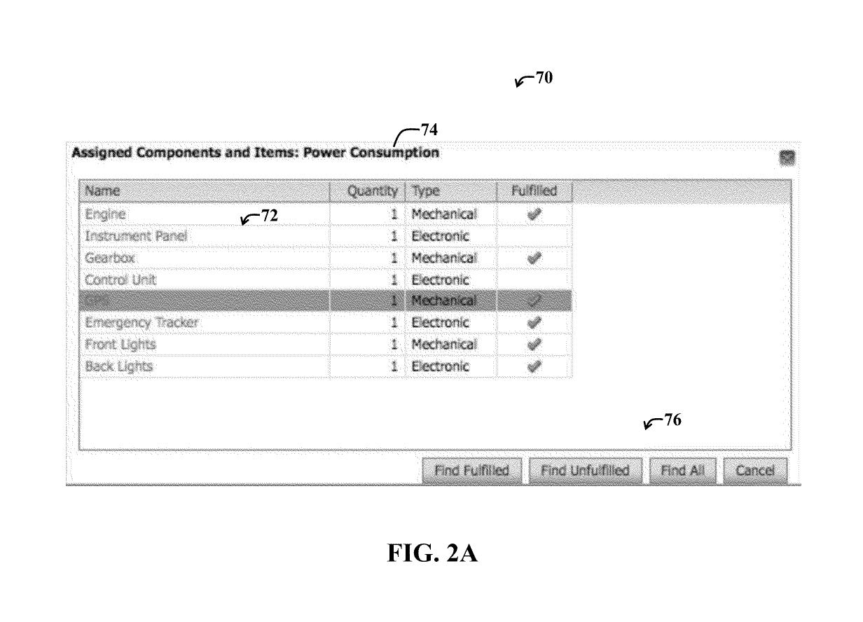

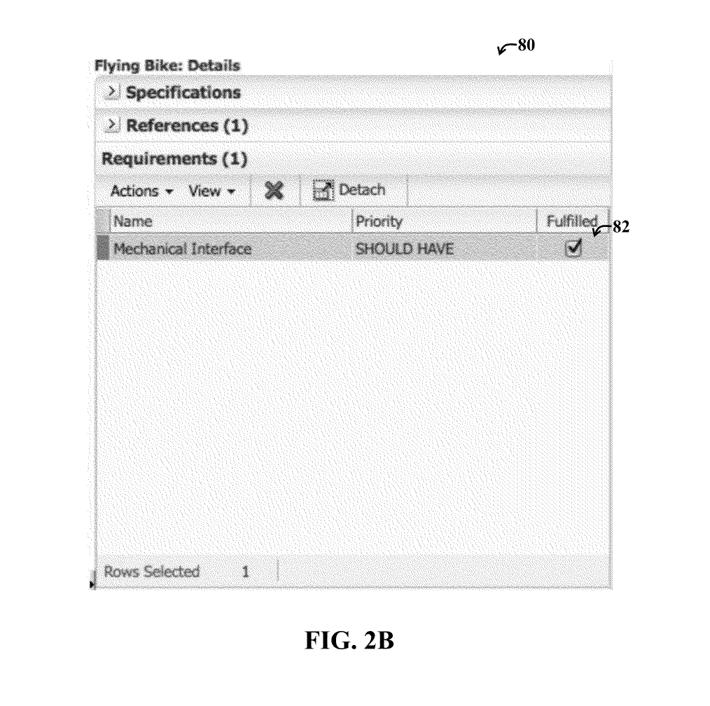

FIG. 2A shows a sixth example user interface display screen 70 indicating concepts 72 that have been assigned to a particular requirement 74 (e.g., power consumption) and further showing user options 76 to search for assigned concepts based on whether the concepts are considered to have fulfilled the identified requirement.

FIG. 2B shows a seventh example user interface display screen 80 with user options 82 for marking a concept as being fulfilled when the concept has been determined, e.g., by an engineer working on a concept, to be sufficiently mature to fulfill, i.e., to meet an associated requirement. The user interface display screen 80 may be accessible via the details panel section 16 (or version thereof) of FIG. 1A.

Hence, concept components, i.e., sub-concepts, can be assigned to requirements to facilitate determining which requirements should/could be fulfilled by which concept components. Once the definition and/or design of the concept component is mature enough to readily fulfill the requirement, a user can check the fulfilled flag 82 in the requirements table 80 of the concept component details panel (e.g., the details panel 16 of FIG. 1A).

Subsequently, analysis can readily be performed across the whole concept and accompanying structure or sub-structure to find out how many of the assigned requirements have already been fulfilled by the current product concept or how much more concept design remains to be done.

Hence, the user interface display screens FIGS. 2A and 2B provide various user interface display screens for facilitating managing traceability relationships between product requirements and conceptual product design fulfillment, i.e., for facilitating viewing, tracing, and managing relationships or associations between product requirements, concepts, and concept fulfillment status. Concept fulfillment status may represent an indication as to whether a given concept fulfills a given requirement that is associated with the concept.

An example method that may be implemented via the embodiments of FIGS. 1A, 2A, and 2B and underlying software includes accessing data indicating one or more concepts associated with an innovation; retrieving data indicating one or more requirements associated with the innovation; providing a first user option to associate a concept with a requirement, resulting in one or more concepts being associated with a requirement; providing a second user option to select a requirement; and providing a third user option to trigger display of a user interface display screen illustrating a set of one or more concepts that are associated with the selected requirement.

Facilitating Visually Depicting and Analyzing Health and/or Strength (or other Attributes or Characteristics) of Relationships Between Objects Related to an Innovation, Such as Concepts, Alternate Concepts and Associated Structures, Concept Requirements, Ideas, Features, and Portfolios

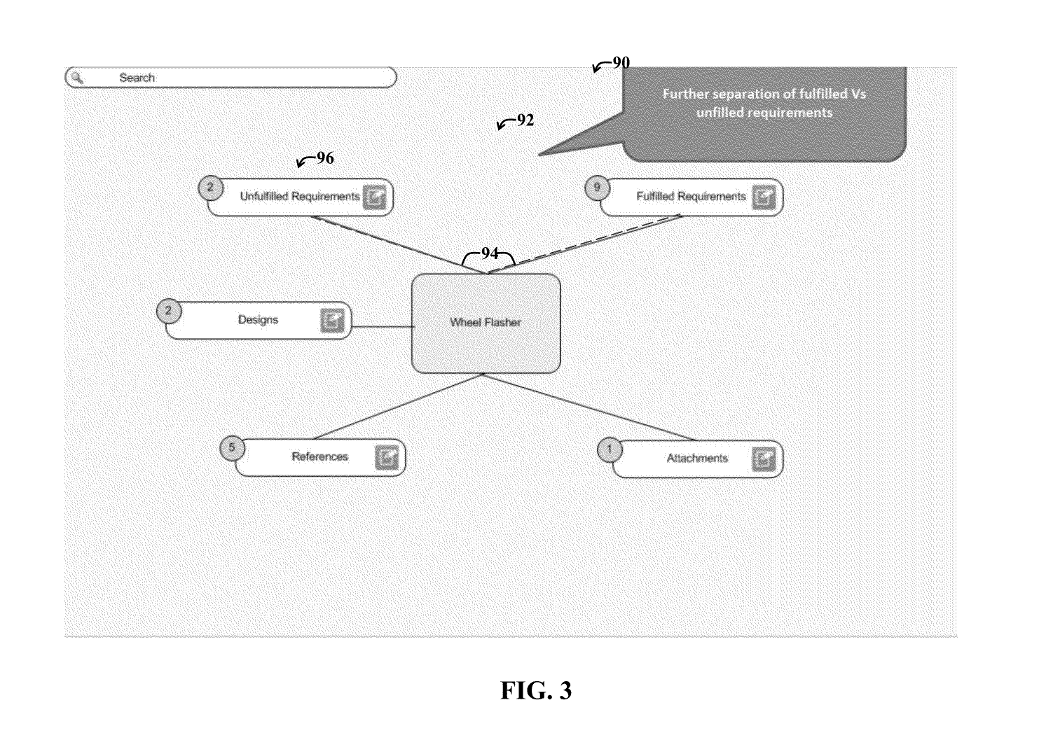

FIG. 3 shows an eighth example user interface display screen 90 depicting an example concept structure 92 and accompanying example indications 94 of health or strength of one or more associations (e.g., as represented by links connecting nodes to a parent node, such as “Wheel Flasher” in the present example embodiment) between concepts 96, e.g., as represented by leaf nodes of the concept structure visualization 92.

The example visualization 92 may include any number of nodes corresponding to objects or categories, which each may include various other nodes or categories. For example, the “Fulfilled Requirements” node includes an indicator showing that nine sub-nodes are included within the “Fulfilled Requirements” category.

Selection of the “Fulfilled Requirements” node may trigger display of nine different nodes extending from the “Fulfilled Requirements” node. Each of the resulting newly displayed nodes may be connected to the parent “Fulfilled Requirements” node via a color coded (or otherwise visually coded or made visually distinguishable) link indicating a status or strength/health measurement associated with the relationship, i.e., association between each child node and a parent node. Alternatively, or in addition, different displayed features of a node, such as node outline, node background, node shape, node size, nodes spacing relative to other nodes, and so on, may be adjusted to indicate different information or scores characterizing relationships between the different nodes of the visualization 92.

Furthermore, note that the various nodes 96 are merely illustrative. In certain embodiments, each of the nodes 96 may represent a sub-concept of a concept represented by a parent node, e.g., the “Wheel Flasher” node. In the present example embodiment, the “Wheel Flasher” node may represent an overall concept, i.e., innovation, with various subcategories; may represent a subcomponent or sub-concept of another concept (not shown); and so on.

Hence, the visualization 92 may represent a graphical representation of a method for visually depicting and analyzing the health/strength of one or more relationships between objects, such as between objects representing an idea, feature, requirements, requirement fulfillment (design, test) conceptual product structures (also simply called concept structures), alternative conceptual product structures, items, components, portfolios, and so on.

An example method that may be adapted for use with the embodiment of FIG. 3 and underlying software includes accessing data indicating one or more concepts associated with an innovation characterized by a concept structure, wherein the concept structure includes a hierarchy of the one or more concepts; determining one or more associations between a concept and a requirement, wherein the concept is part of the concept structure; ascertaining a measurement pertaining to the one or more associations; and displaying a visualization that graphically represents at least a portion of the structure in combination with an indication of the measurement.

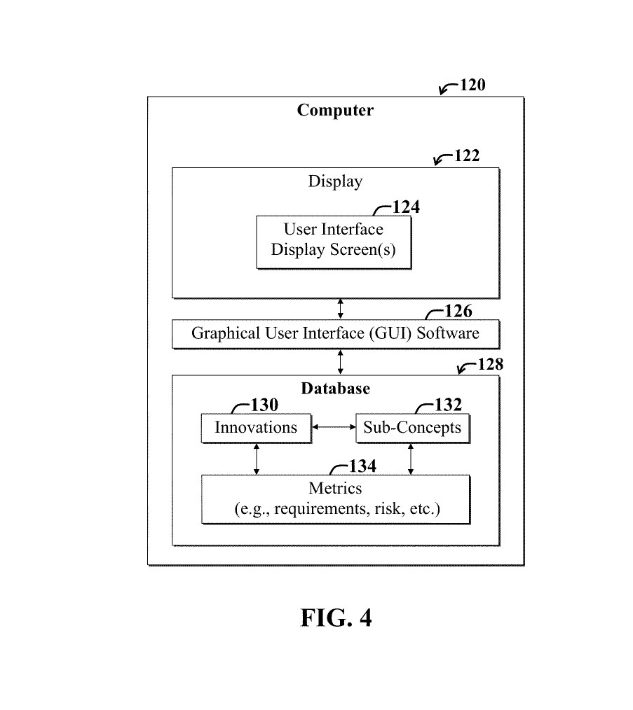

FIG. 4 is a diagram of an example computer system 120 adapted for use with the embodiments of FIGS. 1-3. The example system 120 includes a database 128 for storing information pertaining to innovations 130, associated sub-concepts 132, and metrics 134 associated with the innovations and/or sub-concepts 132. Additional information, e.g., hierarchical concept structure information; information pertaining to relationship strengths between concepts or metrics, and so on, may be maintained in the innovations portion 130 of the database 128 or in another area of the database 128.

Information in the database is user accessible and manipulatable via graphical user interface software 126, which interfaces the display 122 with the database 128 and includes computer code for facilitating rendering user interface display screens 124, accompanying user interface controls, visualizations, and so on.

Although the description has been described with respect to particular embodiments thereof, these particular embodiments are merely illustrative, and not restrictive. For example, while various example user interface display screens illustrate example concepts as physical devices, such concepts may include software or other non-physical products, services, or category of innovation.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating concept management, the method comprising:
providing a first user option to define one or more alternate solution categories for one or more concepts, wherein each alternate solution category is associated with an innovation comprising a structure of concepts, and wherein an alternate solution category is associated with an alternate solution structure;
providing a second user option to define a concept as an alternate solution concept belonging to an alternate solution category; and
associating one or more metric attributes with an alternate solution concept.

2. The method of claim 1, further including providing a third user option to modify a metric attribute assigned to an alternate solution concept.

3. The method of claim 1, further including providing a fourth user option to trigger a comparison of different alternate solution categories that illustrates one or more metrics associated with different alternate solution structures corresponding to a collection of one or more alternate solution concepts of an alternate solution category.

4. The method of claim 3, further including proving a fifth user option initiate creation of one or more associations between a concept and one or more concept requirements.

5. The method of claim 4, wherein the one or more alternate solution categories include a low cost solution category.

6. The method of claim 5, wherein the one or more alternate solution categories include a high cost solution category.

7. The method of claim 4, wherein the innovation includes a concept for a product, and wherein the concept for a product includes one or more sub-concepts for one or more components of the product.

8. The method of claim 7, wherein the one or more sub-concepts for one or more components of the product are included in a first solution structure.

9. The method of claim 8, wherein the alternate solution structure includes a user selected alternative to the first solution structure.

10. The method of claim 4, further including providing the first user option, the second user option, and the third user option via a user interface display screen that includes a first section indicating one or more concept structures, a second section indicating one or more requirements associated with one or more concept structures indicated in the first section, and a third section indicating one or more details pertaining to a concept structure indicated in the first section.

11. The method of claim 3, wherein the one or more metric attributes include a measurement of supply-chain risk.

12. The method of claim 3, wherein the one or more metric attributes include a measurement of cost associated with a concept.

13. The method of claim 3, wherein the one or more metric attributes include a compliance measurement.

14. The method of claim 3, wherein the one or more metrics include an aggregated metric attribute associated with plural alternate solution categories.

15. The method of claim 3, further including graphically depicting results of the comparison via a visualization that graphically illustrates one or more values for the one or more metrics for one or more alternate solution categories.

16. The method of claim 15, wherein each of the one or more alternate solution categories are associated with a collection of one or more alternate solution structures.

17. The method of claim 15, wherein the visualization includes a spyder visualization.

18. The method of claim 17, wherein the one or more metrics include a calculation of risk associated with each alternate solution concept, and wherein the one or more metrics include a value assigned to one or more requirements that are associated with each alternate solution concept.

19. An apparatus comprising:
a digital processor coupled to a display and to a processor-readable storage device, wherein the processor-readable storage device includes one or more instructions executable by the digital processor to perform the following acts:
providing a first user option to define one or more alternate solution categories for one or more concepts, wherein each alternate solution category is associated with an innovation comprising a structure of concepts, and wherein an alternate solution category is associated with an alternate solution structure;
providing a second user option to define a concept as an alternate solution concept belonging to an alternate solution category; and
associating one or more metric attributes with an alternate solution concept.

20. A processor-readable storage device including instructions executable by a digital processor, the processor-readable storage device including one or more instructions for:
providing a first user option to define one or more alternate solution categories for one or more concepts, wherein each alternate solution category is associated with an innovation comprising a structure of concepts, and wherein an alternate solution category is associated with an alternate solution structure;
providing a second user option to define a concept as an alternate solution concept belonging to an alternate solution category; and
associating one or more metric attributes with an alternate solution concept.

21. A method for facilitating concept management, the method comprising:
accessing data indicating one or more concepts associated with an innovation;
retrieving data indicating one or more requirements associated with the innovation;
providing a first user option to associate a concept with a requirement, resulting in one or more concepts being associated with a requirement;
providing a second user option to select a requirement; and
providing a third user option to trigger display of a user interface display screen illustrating a set of one or more concepts that are associated with the selected requirement.

22. The method of claim 21, further including indicating, via a user interface graphic, whether one or more concepts of the set of one or more concepts fulfills the selected requirement.

23. The method of claim 21, further including providing a fourth user option to search for concepts that have been marked as fulfilling the selected requirement.

24. The method of claim 21, further including providing a fifth user option to trigger display of a user interface screen illustrating a set of one or more requirements that are associated with a selected concept.

25. A method for facilitating concept management, the method comprising:
accessing data indicating one or more concepts associated with an innovation characterized by a concept structure, wherein the concept structure includes a hierarchy of the one or more concepts;
determining one or more associations between a concept and a requirement, wherein the concept is part of the concept structure;
ascertaining a measurement pertaining to the one or more associations; and
displaying a visualization that graphically represents at least a portion of the structure in combination with an indication of the measurement.

26. The method of claim 25, wherein the measurement includes an indication of health of an association.

27. The method of claim 25, wherein the measurement includes an indication of a strength of an association.
